(19) United States
(12) Patent Application Publication
(10) Pub. No.: US 2020/0161844 A1
(43) Pub. Date: May 21, 2020

(54) INNERDUCT HAVING MULTIPLE SIZED CHAMBERS

(71) Applicant: Milliken & Company, Spartanburg, SC (US)

(72) Inventors: Steven L. Bedingfield, LaGrange, GA (US); Xiaodong Cao, Shanghai (CN); Kai Chen, Shanghai (CN); Jun Liu, Shanghai (CN)

(21) Appl. No.: 16/674,391

(22) Filed: Nov. 5, 2019

Related U.S. Application Data
(60) Provisional application No. 62/769,716, filed on Nov. 20, 2018.

(51) Int. Cl. H02G 3/04

(52) U.S. Cl. CPC H02G 3/0406; H02G 3/0437

(57) ABSTRACT

A flexible innerduct having a seam region and a chamber region, where the innerduct structure contains at least two flexible, longitudinal chambers, each chamber designed for enveloping at least one cable. The flexible innerduct comprises at least one strip of textile material, where each strip of textile material comprises a first edge and a second edge and extends in the longitudinal direction. All of the first and second edges of the strips are located in the seam region. Each strip of textile material extends outwards from the seam region, folds about a fold axis located in the chamber margin region and returns to the seam region forming a chamber. The chamber length, defined to be the distance between the seam region and the fold axis of the chamber, is different between at least two of the flexible, longitudinal chambers.

### RELATED APPLICATIONS

This application claims priority to co-pending U.S. provisional patent application 62/769,716, which is herein incorporated by reference in its entirety.

### TECHNICAL FIELD

This invention relates generally to innerduct structures useful to position cables in conduit.

### BACKGROUND

The use of a flexible innerduct structures within conduits serve multiple functions, including segregating individual cables into compartments or channels within the innerduct, to maximize the number of cables that may be positioned in a conduit, and facilitating insertion of cables into the conduit by preventing cable-against-cable friction and providing a tape or rope inside each compartment of the innerduct, for pulling the cable into the conduit.

Flexible innerduct structures made of textiles can have various shapes such as a “shared wall configuration”, a “tear-drop configuration”, and a tube. It would be desirable for an innerduct structure to contain different sized chambers to be customized for the cables to be pulled through and maximize the space within the conduit.

### BRIEF SUMMARY

A flexible innerduct containing one or more strip-shaped lengths of textile material configured to create at least a first and second flexible, longitudinal chamber for enveloping a cable, where the first and second chambers are different sizes.

In another embodiment, a flexible innerduct having a seam region and a chamber region and containing at least two flexible, longitudinal chambers, each chamber designed for enveloping at least one cable. The flexible innerduct contains at least one strip of textile material, where each strip of textile material comprises a first edge and a second edge and extends in the longitudinal direction. All first and second edges of the strips are located in the seam region and each strip of textile material extends outwards from the seam region, folds about a fold axis located in the chamber margin region and returns to the seam region forming a chamber. The chamber length, defined to be the distance between the seam region and the fold axis of the chamber, is different between at least two of the flexible, longitudinal chambers.

In another embodiment, a flexible innerduct having a first chamber region, a second chamber region, and a seam region, where the seam region is located between the first and second chamber regions. The innerduct structure contains at least two flexible longitudinal tubes, where each longitudinal tube forms two chambers, and where each chamber is designed for enveloping at least one cable. At least one of the longitudinal tubes extends from the first chamber region to the second chamber region, the tubes are attached together at an attachment in the seam region, and at least one chamber is larger than at least one other chamber.

### BRIEF DESCRIPTION OF THE DRAWINGS

FIG. 1 is a cross-sectional illustrative view of an embodiment of the flexible innerduct structure containing two flexible longitudinal chambers.

FIG. 2 is a cross-sectional illustrative view of an embodiment of the flexible innerduct structure containing two flexible longitudinal chambers.

FIG. 3 is a cross-sectional illustrative view of an embodiment of the flexible innerduct structure containing two flexible longitudinal chambers.

FIG. 4 is a cross-sectional illustrative view of an embodiment of the flexible innerduct structure containing two flexible longitudinal chambers.

FIG. 5 is a cross-sectional illustrative view of an embodiment of the flexible innerduct structure containing two flexible longitudinal chambers.

FIG. 6 is a cross-sectional illustrative view of an embodiment of the flexible innerduct structure containing two flexible longitudinal chambers.

FIG. 7 is a cross-sectional illustrative view of an embodiment of the flexible innerduct structure containing two flexible longitudinal chambers.

FIG. 8 is a cross-sectional illustrative view of an embodiment of the flexible innerduct structure containing two flexible longitudinal chambers.

FIG. 9 is a cross-sectional illustrative view of an embodiment of the flexible innerduct structure containing two flexible longitudinal chambers.

### DETAILED DESCRIPTION

Flexible innerduct structures have chambers and are used within conduits to help segregate individual cables into compartments or channels within the innerduct, to maximize the number of cables that may be positioned in a conduit, and to facilitate insertion of cables into the conduit by preventing cable-against-cable friction and providing a tape or rope inside each compartment of the innerduct. It would be desirable to have a flexible innerduct with different sized chambers.

“Different sized chambers” in this application means that the cross-sectional area of the chambers is different. The cross-sectional area should be the greatest cross-sectional area that the chamber can be opened to (fully open or inflated). This is caused by the loop that forms the chamber to be a different length. A longer length loop will have a longer chamber length (defined to be the distance between the seam region and the fold axis of the chamber) and will be able to open to a larger cross-sectional area chamber. If one were designing a flexible innerduct structure to hold three smaller cables and one larger cable, the flexible innerduct could be made with three smaller chambers and one larger chamber to create a tailored flexible innerduct that does not use more fabric than needed for the application (as more fabric takes up additional space in the conduit).

The invention relates to a flexible innerduct, comprising one or more strip-shaped lengths of textile material configured to create at least a first and second flexible, longitudinal chamber for enveloping a cable, wherein the first and second chambers are different sizes.

The conduits that the flexible innerducts are used in may be of any suitable size (inner or outer diameter), material, and length. Conduits may also be referred to as ducts, pipes, elongated cylindrical elements, and others.

To form more than one chamber in an innerduct structure, typically a seam is used to attach the layers together (this could be multiple pieces of textile, a textile folded onto itself, or a combination of both). This seam may be formed by any suitable means including sewing, gluing, or ultrasonics.

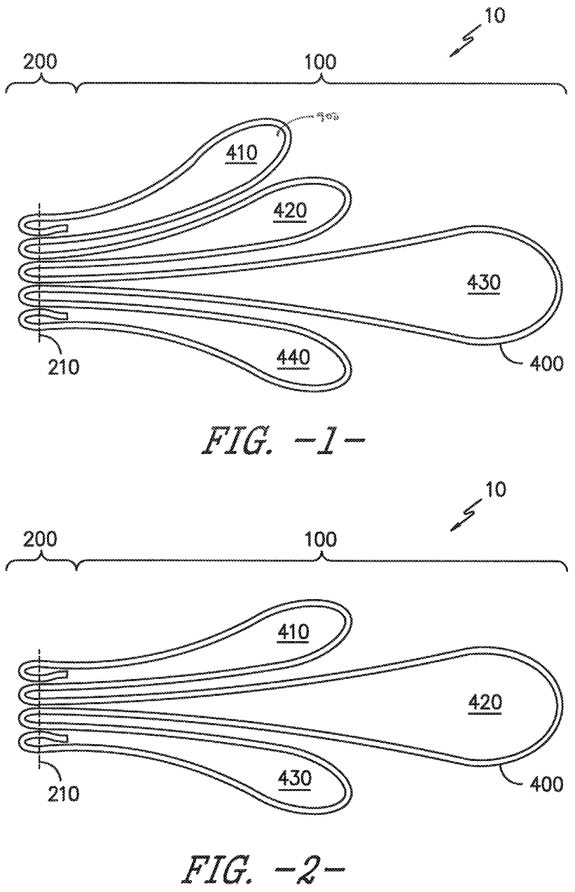

Referring to FIG. 1, there is one embodiment of a flexible innerduct according to the invention. In this embodiment, the innerduct is in a “tear-drop” type configuration where all the chambers are on one side of the attachment. The flexible innerduct 10 contains a chamber region 100 and a seam region 200 and is formed from a single strip-shaped length of textile material 400. The textile material 400 has a first edge and a second edge and extends in the longitudinal direction. The first and second edges of the strip are located in the seam region 200. The strip of textile material extends outwards from the seam region, folds about a fold axis 900 (only one fold axis is labeled in the illustrations, but each chamber made from a folded strip of fabric contains a fold axis) located in the chamber margin region and returns to the seam region forming a chamber. In this embodiment, this is repeated 4 times to create four chambers. The first 410, second 420, and fourth 440 chambers are approximately the same size, having a chamber length of with 5% of each other. The third chamber 430 is larger than at least one of the other chambers (in this Figure the third chamber is larger than all the other chambers), the length of textile material to form the chamber is larger and has a longer chamber length (defined to be the distance between the seam region and the fold axis of the chamber) than the other chambers.

Preferably, the chamber length difference between at least two of the chambers is at least about 10% different, more preferably at least about 20% different, more preferably at least about 45% different. In another embodiment, the cross-sectional area of one chamber fully expanded (meaning that the chamber was blown up to its largest volume) is at least about 20% different, more preferably at least about 40% different, more preferably at least about 90% different.

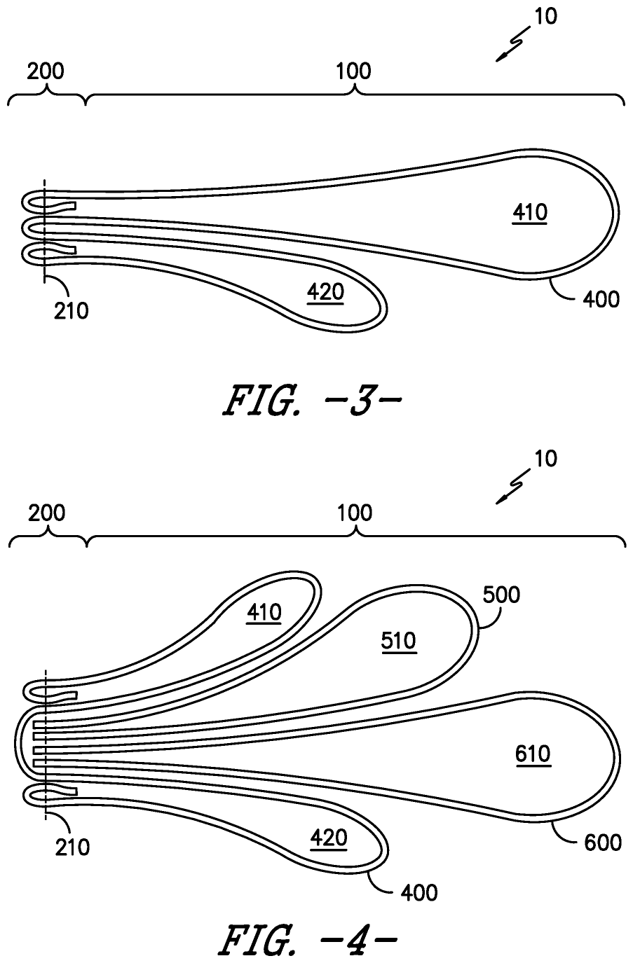

FIG. 2 is another embodiment of the invention similar to FIG. 1, except the single textile material 400 is configured to make three chambers 410, 420, 430. In this embodiment, the second chamber 420 is larger than the first chamber 410 and third chamber 430.

FIG. 3 is another embodiment of the invention similar to FIG. 1, except the single textile material 400 is configured to make two chambers 410 and 420. In this embodiment, the first chamber 410 is larger than the second chamber 420.

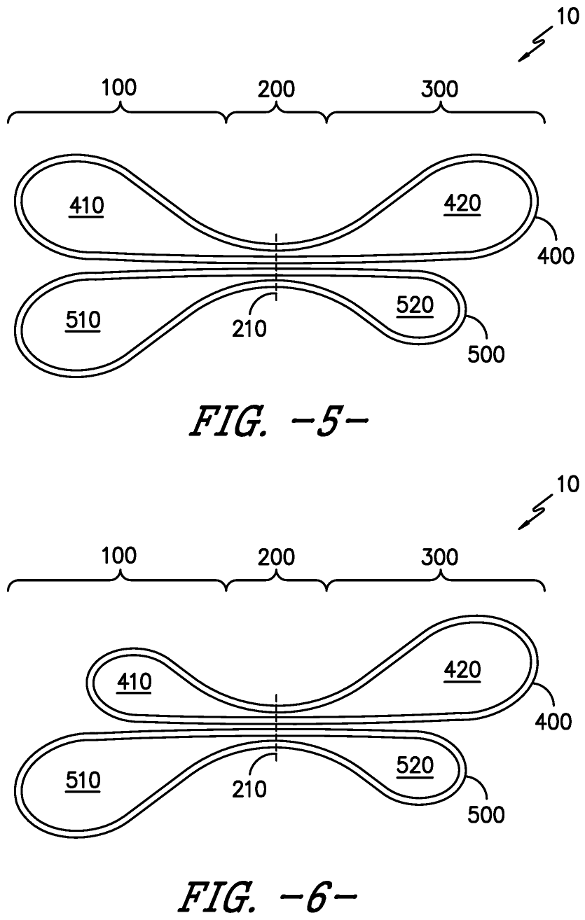

FIG. 4 is another embodiment of the invention similar to FIG. 1, with four chambers in a tera-drop like configuration. The flexible innerduct 10 of this Figure was made using 3 strip-shaped lengths of textile material 400, 500, and 600. The textile material 400 forms the first 410 and fourth 420 chambers, the second textile material 500 forms the second chamber 510, and the third textile material 600 forms the third chamber 610. As can be seen in this embodiment, the third chamber 610 is the largest chamber, then the second chamber 510 is the second largest, and the first 410 and fourth 420 chambers are approximately the same size and are the smallest chambers.

Where the largest and/or smallest chambers are located within the flexible innerduct 10 is a product of the desired end result and product. In one embodiment, the larger (or largest) chambers are towards the center of the innerduct structure, meaning that the largest chamber is not the first or last chamber in the innerduct, but is one of the middle chambers. A larger chamber may be easier to open and as the inner chambers tend to be more difficult to open (which results in high pulling forces needed to pull cables and the like through the chamber), having a larger chamber as one of the inner chambers would reduce the pulling force.

In another embodiment, the largest chamber is located as one of the outer chambers (the first or last chamber). If a larger cable is to be pulled through the flexible innerduct structure, then having the larger chamber as one of the outer chambers may be beneficial so the chamber can open fully without being impeded by having chambers on both sides of the largest chamber.

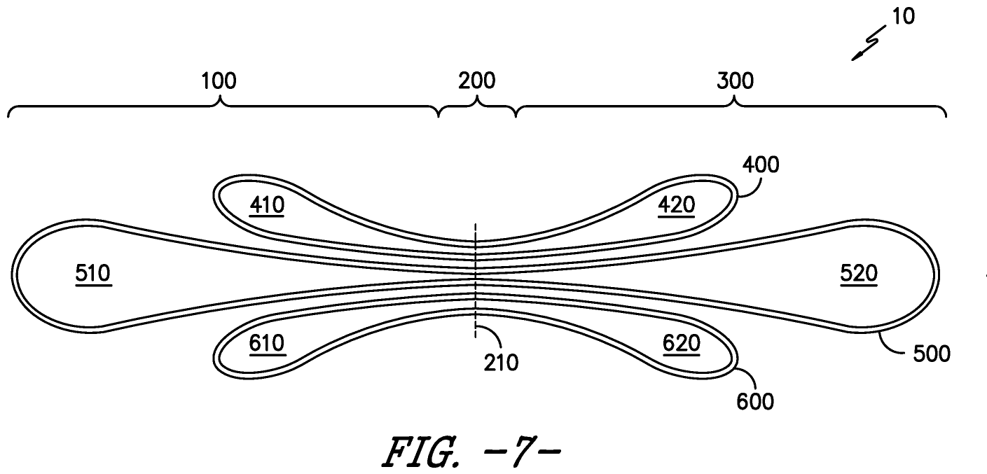

Referring now to FIG. 5, there is shown an alternative embodiment of the innerduct flexible innerduct 10. The flexible innerduct 10 contains three regions, a first chamber region 100, a seam region 200, and a second chamber region 300. In the flexible innerduct 10 of FIG. 5, the flexible innerduct 10 contains two flexible longitudinal tubes 400, 500, that each form 2 chambers (for cables, pull tapes, and the like) 410, 420 and 510, 520 respectively. At least one of the tubes 400, 500 (in this case both) extend from the first chamber region 100 to the second chamber region 300. The tubes 400, 500 are attached together using attachment 210 within the seam region 200. At least one of the chambers is different than the others. In this Figure, chamber 520 is smaller than the other chambers 410, 420, and 510 (which are approximately the same size). This difference in size is caused by attaching two tubes 400, 500 together that are of difference sizes. Tube 500 has a smaller circumference than tube 400.

In another embodiment, the difference in chamber sizes within the flexible innerduct 10 formed by tubes is to take a plurality of approximately the same sized tubes and then offset them before attaching them in the seam region 200. This can be seen in FIG. 6. Tubes 400 and 500 have approximately the same circumference, but they are offset prior to attaching them together such that the resultant innerduct 10 has two larger chambers 420, 510 and two smaller chambers 410, 520.

In another embodiment, the attachment means 210 is off-center, meaning that it is not in the center of the structure. This creates chambers in one of the margin regions to be larger than the chambers in the other margin region. This may be preferred to accommodate wires, cables, pull tapes, etc. of varying sizes.

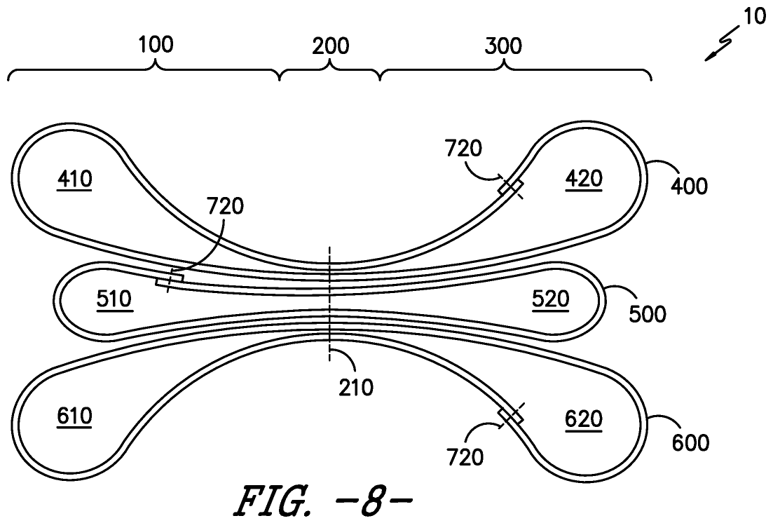

FIG. 7 shows a cross-sectional illustration similar to the flexible innerduct in FIG. 5 except that the innerduct contains three tubes 400, 500, and 600. In this embodiment, the circumference of the second tube 500 is larger than the first tube 400 and the second tube 600. This results in the chambers 510 and 520 being larger than the chambers 410, 420, 610, 620.

Where the largest and/or smallest chambers are located within the flexible innerduct 10 with tubes is a product of the desired end result and product. In one embodiment, the larger (or largest) chambers are towards the center of the innerduct structure, meaning that the largest chamber is not the first or last chamber in the innerduct, but is one of the middle chambers. A larger chamber may be easier to open and as the inner chambers tend to be more difficult to open (which results in high pulling forces needed to pull cables and the like through the chamber), having a larger chamber as one of the inner chambers would reduce the pulling force.

In another embodiment, the largest chamber is located as one of the outer chambers (the first or last chamber). If a larger cable is to be pulled through the flexible innerduct structure, then having the larger chamber as one of the outer chambers may be beneficial so the chamber can open fully without being impeded by having chambers on both sides of the largest chamber.

The tubes of FIGS. 5-7 are seamless tubes, typically made on a circular weaving machine. Seamless tubes may be preferred for some applications as they do not have additional seams to break or snag while installing them. Additionally, in only one production pass, the tube is formed and ready to be made into the flexible innerduct.

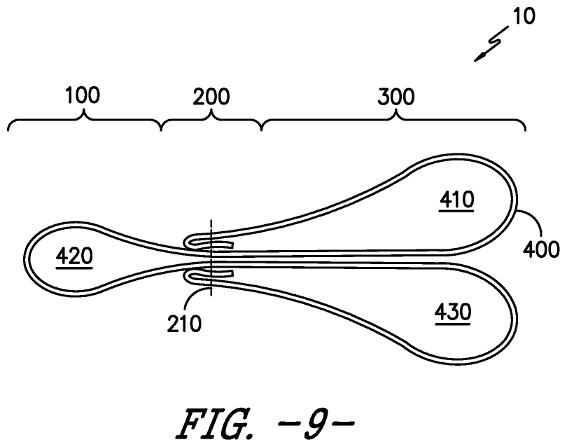

In another embodiment as shown in FIG. 8, the flexible innerduct 10 is made from tubes 400, 500, 600 having a seam. The tubes 400, 500, 600 are each formed from a strip-shaped textile material that is then made into a tube having a seam along the longitudinal length of the tube shown as 720 in the illustration. This seam may be stitched, ultrasonically welding, melted, or any other suitable attachment means.

In FIG. 8, the circumference of the second tube 500 is smaller than the first tube 400 and the second tube 600. This results in the chambers 510 and 520 being smaller than the chambers 410, 420, 610, 620.

Creating tubes from a strip-shaped textile material instead of as a seamless tube (using circular weaving or knitting for example) has many benefits. The first benefit is around splicing. It is much easier to splice flat strip-shaped textile materials together to create longer lengths then turn the strips into tubes than it is to splice together seamless tubes. Secondly, different sized tubes can be manufactured more easily with less machine downtime. Simply slitting the strip-shaped textile materials to different widths before turning them into tubes can create tubes with different diameters. For many seamless tube manufacturing processes, the setup of warps and/or weft would have to be redone to change the diameter of the tube being produced.

The seam 720 can be placed in any suitable location about the circumference of the tube, including any of the 3 regions 100, 200, 300 and even in the attachment 210 itself. The seam 720 may be formed by any suitable method including, but not limited to, stitching, ultrasonic welding, and gluing. The seams on each tube within the flexible innerduct 10 may be in different locations. In one embodiment, the seams 720 are within the attachment 210 and the attachment 210 serves to attach the strips into tubes and the tubes together (in this embodiment, seams 720 and the attachment 210 may be the same). In one embodiment, the innerduct is made from a combination of tubes having seams and seamless tubes.

Preferably, the tubes 400, 500, 600 are only attached together at the attachment 210 within the seam region 200 and are not attached in the first chamber region 100 or the second chamber region 200 (or in the case of structures similar to FIGS. 1-4, only the first chamber region 100). This allows the chambers to spread and better fill the conduit. When the flexible innerducts shown in FIGS. 5-8 are installed into a conduit the chambers of the flexible innerduct 10 spread to fill the conduit and have a dragon fly like appearance in cross-section.

Referring now to FIG. 9, there is shown an additional embodiment of the flexible innerduct 10. The flexible innerduct 10 contains three regions, a first chamber region 100, a seam region 200, and a second chamber region 300. In the flexible innerduct 10 of FIG. 9, the flexible innerduct 10 contains one striped-shaped textile 400 that forms three flexible longitudinal chambers 410, 420, 430. Each of the chambers is designed for enveloping at least one cable. Chamber 420 is in the first chamber region and chambers 410 and 430 are in the second chamber region.

Each strip-shaped textile 400 (and 500, 600 if the innerduct contains multiple strips of textile material) has a first edge 400a and a second edge 400b (or 500a, 500b, 600a, 600b respectively). The first and second edges 400a, 400b are located in the seam region 200 of the flexible innerduct flexible innerduct 10. Each strip 400 extends outwards from the seam region 200 to either the first chamber region 100 or the second chamber region 300, folds about a fold axis, and then returns to the seam region 200 forming the longitudinal chamber 410. The flexible innerduct 10 may contain 2 or 3 or more strip-shaped textiles 400, 500 and at least one of those strip shaped textiles 400, 500 extends from the first chamber region 100 to the second chamber region 300. The flexible innerduct contains a fold in at least one strip-shaped textile in the first chamber region 100 and a fold in at least one strip-shaped textile in the second chamber region 200.

In the flexible innerduct of FIG. 9, the first edge 400a of the strip-shaped textile 400 is in the seam region 200 of the flexible innerduct 10, then extends outward into the second chamber region 300, folds in the second chamber region 300, extends over to the first chamber region 100 (passing through the seam region 200), folds in the first chamber region 100, extends outward into the second chamber region 300, folds in the second chamber region 300, and then returns to the seam region where the second edge 400b is located. The attachment means 210 in the seam region holds the strip-shaped textile together and in place. In this embodiment, the loop forming the second chamber 420 in the first chamber region 100 is shorter than the loops forming the chambers 410, 430 in the second chamber region. This forms an innerduct 10 with a smaller chamber 420 than chambers 410 and 430. While this Figure is shown with 3 chambers, the innerduct can have any number of chambers two and greater, with at least one chamber located in the first chamber region 100 and at least one chamber located in the second chamber region 300. In another embodiment, the innerduct may have 3, 4, 5, 6, or more chambers with at least one of those chambers have a different size than at least another chamber and be made from a single or multiple strips of textile material.

The number of folds in the strip-shaped textile materials in the first and second chamber region equals the number of chambers on that side of the attachment means. For example, if the textile 400 has one fold in the first chamber region and two folds in the second chamber region, then the structure will have one chamber on the first margin side of the attachment means and two chambers on the second margin side. This is shown, for example, in FIG. 9.

When strips of fabric are used in a folded orientation (such as in FIGS. 1-4 and 9), it may be preferred to have these edges folded over in the seam region 200. This may be preferred to prevent the edges of the fabric getting caught on other materials during the manufacture, installation, and/or use of the flexible innerduct 10 and helps prevent the edge of the strip-shaped textile from coming loose from the attachment means 210. For example, the attachment means 210 may be a line of stitching and if there is some fraying of the edge of the strip-shaped textile, then some of the textile may come loose and one or more of the chambers may not be fully closed.

Preferably, the textile(s) are only attached together and to themselves at the attachment means 210 and are not attached in the first chamber region 100 or second chamber region 300. This allows the chambers to spread and better fill the conduit.

The attachment means 210 may be any suitable way of attachment. In one preferred embodiment, the attachment means 210 is a sewn seam made by sewing the layers of textile together. Other methods of forming the attachment include stapling or riveting the textiles at intervals along the length, ultrasonic welding, or fastening the fabric with a hot melt or solvent based adhesive. The textiles may also be provided with relatively low temperature melting fibers, which can be melted and allowed to cool, thereby fusing the structure together at the attachment.

The strip-shaped textile(s) may be made from any suitable fabric material including, but not limited to, woven, knit, and nonwoven textiles. For embodiments using more than one strip-shaped textile, all the textiles within the structure may be the same or different textiles can be used together in the structure.

The terms “pick,” “picks,” “picks per inch” and “ppi” are intended to refer to (a) one filling yarn carried through a shed formed during the weaving process and interlaced with the warp yarns; and (b) two or more filling yarns carried through a shed during the weaving process, either separately or together, and interlaced with the warp yarns. Thus, for the purposes of determining the picks per inch of a woven textile, multiple-inserted filling yarns are counted as a single pick.

The terms “multiple-insertion” and “double-insertion” are intended to include (a) multiple filling yarns inserted in the shed of the loom together; (b) multiple filling yarns inserted separately, while the shed of the loom remains the same; and (c) multiple filling yarns inserted separately, where the shed of the looms remains substantially the same, that is, the position of 25% or less of the warp yarns are changed between insertions of the yarns.

In one embodiment, the strip-shaped textile is preferably a plain weave, although other constructions, such as twill or satin weaves, are within the scope of the invention. The individual warp yarns (“ends”) are selected to provide high tenacity and low elongation at peak tensile load. By way of example, the warp yarns may be selected from polyesters, polyolefins, such as polypropylene, polyethylene and ethylene-propylene copolymers, and polyamides, such as nylon and aramid, e.g. KEVLAR®. Yarns having a peak elongation at peak tensile load of 45% or less, preferably 30% or less, may be used. Monofilament yarns, including bi- and multi-component yarns, have been found to be particularly useful in innerduct applications. Multifilament yarns may also be used in the warp. Warp yarns having a denier of from 350 to 1,200, preferably 400 to 750, may be employed. The end count (yarns per inch in the warp) may range from 25 to 75 ends per inch, preferably from 35 to 65 ends per inch. In one embodiment of the invention a plain weave textile having 35 to 65 ends per inch of 400 to 750 denier monofilament polyester warp yarns is provided. Preferably, the warp yarns comprise monofilament yarns, more preferably all the warp yarns are monofilament yarns. Preferably, the warp yarns comprise polyester as polyester has been shown to create good cost and performance yarns.

By selecting warp yarns having a relatively low elongation at peak tensile load, it is possible to minimize lengthwise elongation of the flexible innerduct during installation of the innerduct in a conduit, thereby avoiding “bunching” of the innerduct. Additionally, the elongation potential in the warp direction of the textile incorporated into an innerduct can be minimized by reducing the warp crimp during the weaving process. For example, the warp crimp may be reduced by increasing the tension on the warp yarns during weaving to achieve a warp crimp of less than 5%, as measured by ASTM D3883—Standard Test Method for Yarn Crimp and Yarn Take-Up in Woven Fabrics. Reducing the warp crimp in the fabric, especially a plain weave fabric, results in an increase in the crimp of the filling yarn, which has the further advantage of increasing the seam strength along the longitudinal edges of the sections of fabric used to construct the innerduct.

Preferably, the fill yarns comprise monofilament yarns, preferably monofilament nylon yarns. In one embodiment, at least a portion of the filling yarns are multiple-inserted multifilament yarns in the woven textile. In various embodiments of the invention, the woven textile may be constructed with at least one-fourth of the picks being multiple-inserted multifilament yarns, at least one-third of the picks being multiple-inserted multifilament yarns, or even at least one-half of the picks being multiple-inserted multifilament yarns. Strip-shaped textile in which the multiple-inserted multifilament yarns are double-inserted have been found to be particularly useful for making innerduct structures.

In one embodiment, at least a portion of the filling yarns are multiple-inserted multifilament yarns. Each multifilament yarn is made of continuous filaments of a synthetic polymer. By way of example, the yarns may be selected from polyesters, polyolefins, such as polypropylene, polyethylene and ethylene-propylene copolymers, and polyamides, such as nylon and aramid. Each yarn may contain from 30 to 110 individual filaments, typically from 50 to 90 individual filaments, and the denier of the yarn may range from 200 to 1,000, typically from 500 to 800. Each multifilament yarn may be constructed of one, two or more plies. The multiple-inserted multifilament yarns may be inserted in the shed of the loom individually or together.

The multifilament yarns may be textured yarns, that is, yarns which have been treated to provide surface texture, bulk, stretch and/or warmth. Texturing may be accomplished by any suitable method, as is known to those skilled in the art. Of interest are textured polyester yarns. By way of example, the polyester may be polyethylene terephthalate. Other examples of suitable polyester polymers for use in fiber production may be found in U.S. Pat. No. 6,395,386 B2.

In one embodiment of the invention, the fill yarns are provided in an alternating arrangement of monofilament yarns and multifilament yarns, as disclosed in US Patent Application No. 2008/0264669 A1. The phrase “alternating arrangement” refers to a repeating pattern of picks of monofilament to multifilament yarns. By way of example, the arrangement of monofilament to multifilament yarns may be 1:1, 1:2, 1:3, 2:3, 3:4, or 3:5. It can be understood that some or all the multifilament yarn picks may be multiple-inserted multifilament yarns.

Bi- or multi-component yarns of various configurations are intended to be included within the definition of monofilament yarns used in the alternating pattern in the filling direction of the fabric.

When monofilament yarns are included in the filling direction of the textile, the monofilament filling yarns may be selected from polyesters, polyolefins, such as polypropylene, polyethylene and ethylene-propylene copolymers, and polyamides, such as nylon, particularly nylon 6, and aramid. Monofilament filling yarns having a denier of from 200 to 850, preferably 300 to 750, may be employed. In one embodiment of the invention, two different size monofilament yarns are incorporated into the alternating pattern in the filling direction. For example, one of the monofilament filling yarns may have a denier of less than 435 and the other monofilament filling yarn may have a denier greater than 435.

The pick count (picks per inch in the filling) may range from 12 to 28 picks per inch. One of the advantages of the present invention is that it is possible to provide a fabric at the lower end of the pick count range, to reduce filling rigidity and reduce material and manufacturing costs. Accordingly, strip-shaped textiles having a pick count in the range of 12 to 22 picks per inch are preferred. In one embodiment of the invention a plain weave having from 14 to 22 picks per inch of an alternating pattern of nylon monofilament and double-inserted textured polyester monofilament is provided.

In one embodiment, the strip-shaped textile may have a weave pattern that contains different repeating zones having different weave patterns such as plain, weaves with multiple insertions, and zones with floating yarns. In one embodiment, the strip-shaped textile contains alternating pattern containing first weave zones and partial float weave zones and contains a plurality warp yarns arranged into groupings of warp yarns, wherein each grouping contains between 2 and 10 warp yarns and a plurality of picks of weft yarns. In each first weave zone, the picks of weft yarns comprise a repeating first weft pattern of at least one monofilament yarn, at least one multiple-inserted multifilament yarn, and optionally at least one single-inserted multifilament yarn. In each partial float zone, the picks of weft yarns within the partial float weave zone comprise a repeating second weft pattern of at least one monofilament yarn, at least one multiple-inserted multifilament yarn, and optionally at least one single-inserted multifilament yarn. Only a portion of the warp yarns within at least a portion of the warp groupings float over 3 weft yarns including floating over at least one multiple-inserted multifilament weft yarn in at least a portion of weft pattern repeats, and wherein outside of the floats the non-floating warp yarns pass successively over and under alternating picks of weft yarns. Such a textile is described in US Patent Application Publication 2017/0145603 which is herein incorporated by reference.

The strip-shaped textile may be made as a flat sheet in a conventional weaving machine or in a circular weaving machine and then slit. A traditional weaving machine is typically a faster manufacturing process and multiple diameter strip-shaped textiles can be formed from one manufacturing line (the textile sheet just needs to be slit at different widths).

To draw the fiber optic, coaxial, or other cables through the flexible innerduct, it is desirable to provide pull lines for such purpose. The pull lines are positioned within the compartments of the innerduct, preferably before installation of the innerduct within the conduit. By way of example, the pull lines may be tightly woven, relatively flat strips of material or may be a twisted ropes or multi-ply cords having a substantially round cross-section.

Preferably, the innerduct and the pull line have respective values of elongation percentage which are substantially equal for a given tensile load. If elongation of the innerduct differs substantially from that of a pull line, one of those structures may lag relative to the other when they are pulled together through a conduit during installation, resulting in bunching of the innerduct. The pull lines may be formed of tightly woven, polyester material, which exhibits a tensile strength of between about 400 pounds and about 3,000 pounds.

Generally, a conduit is a rigid or semi-rigid piping or duct system for protecting and routing cables, electrical wiring and the like. The term “cable” is intended to include fiber optic cables, electrical wires, coaxial and triaxial cables, as well as any other line for transmitting electricity and/or electromagnetic signals. By way of example, the conduit may be made of metal, synthetic polymer, such as thermoplastic polymer, clay or concrete. The passageway through the conduit may have a round, oval, rectangular or polygonal cross-section. The present invention finds utility in combination with virtually any conduit system. Depending upon the relative size of the passageway in the innerduct, typically calculated as the inside diameter, persons skilled in the art may select from the width of the innerduct, number of compartments in each innerduct, and number of individual innerducts, to maximize the capacity of the conduit.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A flexible innerduct having a seam region and a chamber region, wherein the innerduct structure comprises at least two flexible, longitudinal chambers, each chamber designed for enveloping at least one cable, wherein the flexible innerduct comprises:
at least one strip of textile material, wherein each strip of textile material comprises a first edge and a second edge and extends in the longitudinal direction,
wherein all first and second edges of the strips are located in the seam region, wherein each strip of textile material extends outwards from the seam region, folds about a fold axis located in the chamber margin region and returns to the seam region forming a chamber, wherein the chamber length, defined to be the distance between the seam region and the fold axis of the chamber, is different between at least two of the flexible, longitudinal chambers.

2. The flexible innerduct of claim 1, wherein at least one strip of textile material extends outwards from the seam region, folds about a fold axis located in the chamber margin region, returns to the seam region forming a chamber, extends outwards from the seam region again, folds about a fold axis located in the chamber margin region, and returns to the seam region forming an additional chamber.

3. The flexible innerduct of claim 1, wherein the one or more strip-shaped lengths of textile material are configured to create at least three longitudinal chambers.

4. The flexible innerduct of claim 1, wherein the one or more strip-shaped lengths of textile material comprise woven fabric.

5. The flexible innerduct of claim 1, wherein the stripes are attached together in the seam region with stitches.

6. The flexible innerduct of claim 1, wherein the textile material stripes are only joined together in the seam region.

7. The flexible innerduct of claim 1, further including a cable in at least one of the chambers.

8. The flexible innerduct of claim 1, further including a pull line in at least one of the chambers.

9. The flexible innerduct of claim 4, wherein the textile material is a woven fabric comprising:
(a) a warp comprised of monofilament yarn ends; and
(b) a filling comprised of a combination of monofilament and multifilament yarn picks,
wherein at least a portion of the multifilament yarn picks are multiple-inserted.

10. The flexible innerduct of claim 1, wherein the textile material is a woven fabric comprising an alternating pattern containing first weave zones and partial float weave zones and comprising:
a plurality warp yarns arranged into groupings of warp yarns, wherein each grouping contains between 2 and 10 warp yarns; and,
a plurality of picks of weft yarns;
wherein in each first weave zone the picks of weft yarns comprise a repeating first weft pattern of at least one monofilament yarn, at least one multiple-inserted multifilament yarn, and optionally at least one single-inserted multifilament yarn,
wherein in each partial float zone the picks of weft yarns within the partial float weave zone comprise a repeating second weft pattern of at least one monofilament yarn, at least one multiple-inserted multifilament yarn, and optionally at least one single-inserted multifilament yarn,
wherein only a portion of the warp yarns within at least a portion of the warp groupings float over 3 weft yarns including floating over at least one multiple-inserted multifilament weft yarn in at least a portion of weft pattern repeats, and wherein outside of the floats the non-floating warp yarns pass successively over and under alternating picks of weft yarns.

11. A conduit comprising one or more of the flexible innerduct of claim 1.

12. A flexible innerduct having a first chamber region, a second chamber region, and a seam region, wherein the seam region is located between the first and second chamber regions, wherein the innerduct structure comprises:
at least two flexible longitudinal tubes, wherein each longitudinal tube forms two chambers, wherein each chamber is designed for enveloping at least one cable, wherein at least one of the longitudinal tubes extends from the first chamber region to the second chamber region, and wherein the tubes are attached together at an attachment in the seam region, and wherein at least one chamber is larger than at least one other chamber.

13. The flexible innerduct of claim 12, wherein the longitudinal tubes each comprise one seam.

14. The flexible innerduct of claim 12, wherein the innerduct structure comprises two flexible longitudinal tubes and four chambers.

15. The flexible innerduct of claim 12, wherein the longitudinal tubes comprise a woven textile.

16. The flexible innerduct of claim 12, further including a cable in at least one of the chambers.

17. The flexible innerduct of claim 12, further including a pull line in at least one of the chambers.

18. The flexible innerduct of claim 12, wherein the longitudinal tubes are made using circular weaving.

19. The flexible innerduct of claim 12, wherein the textile material is a woven fabric comprising an alternating pattern containing first weave zones and partial float weave zones and comprising:
a plurality warp yarns arranged into groupings of warp yarns, wherein each grouping contains between 2 and 10 warp yarns; and,
a plurality of picks of weft yarns;
wherein in each first weave zone the picks of weft yarns comprise a repeating first weft pattern of at least one monofilament yarn, at least one multiple-inserted multifilament yarn, and optionally at least one single-inserted multifilament yarn,
wherein in each partial float zone the picks of weft yarns within the partial float weave zone comprise a repeating second weft pattern of at least one monofilament yarn, at least one multiple-inserted multifilament yarn, and optionally at least one single-inserted multifilament yarn,
wherein only a portion of the warp yarns within at least a portion of the warp groupings float over 3 weft yarns including floating over at least one multiple-inserted multifilament weft yarn in at least a portion of weft pattern repeats, and wherein outside of the floats the non-floating warp yarns pass successively over and under alternating picks of weft yarns.

20. A conduit comprising one or more of the flexible innerduct of claim 12.
